(19) United States
(12) Patent Application Publication
(10) Pub. No.: US 2019/0084856 A1
(43) Pub. Date: Mar. 21, 2019

(54) COMPOSITION AND METHOD OF SCALE CONTROL IN REGULATED EVAPORATIVE SYSTEMS

(71) Applicant: Solenis Technologies, L.P., Schaffhausen (CH)

(72) Inventor: Paul W. Shepperd, Newark, DE (US)

(21) Appl. No.: 15/710,042

(22) Filed: Sep. 20, 2017

(51) Int. Cl. C02F 5/12; C02F 5/10

(52) U.S. Cl. CPC C02F 5/12; C02F 2101/101; C02F 5/10

(57) ABSTRACT

This invention pertains to an anti-scaling composition comprising a blend of a polyamino acid; an anionic carboxylic polymer; and a polymaleic acid. The blend is able to effectively stabilize calcium salts that lead to scale formation in evaporative systems. This “three-component” blend shows high levels of efficacy in acidic high conductivity waters found in many evaporative systems such as sugar and bio-refining.

### BACKGROUND OF THE INVENTION

The current invention relates to compositions for preventing, inhibiting and controlling scaling in aqueous systems comprising a mixture or blend of a polyamino acid, an anionic carboxylic polymer and a polymaleic acid. Aqueous system include, for example, heat exchangers and evaporative equipment such as those found in regulated markets, such as, sugar and bio-refineries. The invention also relates to a method for preventing, inhibiting, cleaning, and/or removing the formation of scaling such as calcium, magnesium, oxalate, sulfate, and phosphate scale, of an aqueous system.

These systems have unique demands due to their high conductivities, high levels of insoluble material, and low pH regimes.

Scaling formation arises primarily from the presence of dissolved inorganic salts in the aqueous system that exists under supersaturation conditions of the process. The salts enter the system from the water and/or from the raw materials being processed themselves. The salts become problematic due to water recycle and concentration in the plant processes. The salts deposit when water is heated or cooled in heat transfer equipment such as heat exchangers, condensers, evaporators, cooling towers, boilers, and pipe walls. Changes in temperature or pH lead to scaling and fouling via the accumulation of undesired solid materials at interfaces. The accumulation of scale on heated surfaces cause the heat transfer coefficient to decline with time and will eventually, under heavy fouling, cause production rates to be unmet. Ultimately, the only option is often to shut down the process and perform a cleanup. This requires a shut down in production as well as use of corrosive acids and chelating agents. The economic loss due to fouling is one of the biggest problems in all industries dealing with heat transfer equipment. Scaling is responsible for equipment failures, production losses, costly repair, higher operating costs, and maintenance shutdowns and often the initiating stage in pitting and corrosion of piping and metal surfaces. For this reason, scale prevention and control may have significant commercial value in protecting capital assets from pre-mature failure.

In order to prevent scaling, a number of scale inhibitors are often employed in the field to prevent, delay, inhibit or otherwise control the scaling process. The presence of scale inhibitors can have a significant effect on nucleation; crystal growth rate and morphology, even when the additive is present in very low concentrations. However, these effects are not easily predicted as subtle changes in the pH, temperature, or types of scale can have significant impact.

In the food and beverage industry (such as beer, wine, concentrate liqueurs, vegetable juice, fruit juice, fuel ethanol, and sugar refining), one of the more common scale components is calcium oxalate). Oxalate is a natural component in plant life and can occur in high levels. During the course of processing the oxalate is extracted and becomes a part of the process waters. In the evaporators a small amount of oxalate will become concentrated and begin scaling upon supersaturation. In the lab we have found that calcium levels between about 75 parts-per-million (ppm) to about 100 ppm are sufficient to cause precipitation of oxalate scale. Calcium oxalate also known as beerstone, and silica are the main components of composite scales formed in the later stages of the evaporation process in sugar mills, and form one of the most intractable scales to remove either by mechanical or chemical means. The removal of the scale is both costly and time consuming because of the tenacious nature of the deposit.

Known methods for treating calcium scale in evaporative systems include a number of chelating and threshold inhibition mechanisms. Most commonly this has been polymers containing carboxylic acids, phosphonate containing polymers, chelating agents such as ethylenediaminetetraacetic acid (EDTA), or small organic acids such as citric acid. Polyaspartic acid has also been used in some applications.

In some instances these materials have been blended in order to increase performance. Phosphonates and polycarboxylates (U.S. Pat. No. 4,575,425), blends of citric, gluconic, and gluconolactone (U.S. Pat. No. 3,328,304), polyacrylamide and alginate or phosphonate (U.S. Pat. No. 3,483,033), phosphonic acids and EDTA (US 20100000579 A1), blends of chelating agents including EDTA (WO 2012/142396 A1), and hydroxycarboxylic acids with citric acid (US 20120277141 A1). There is also disclosed a blend of a polyaspartic acid and a polyacrylic acid as described in patent application US 2015/0251939 (WO 2015/134048 A1). Many of these compositions are shown to be effective to some extent, but often require high doses or materials that do not have proper regulatory clearance for food and beverage products and therefore cannot be used.

Polyaspartic acid has shown some level of efficacy in inhibiting calcium scales in sugar applications but required synthetic modifications to achieve higher performance (U.S. Pat. No. 5,747,635). Polyacrylates have also been applied to similar scales (U.S. Pat. No. 4,452,703). The use of these materials has been limited to doses resulting in very low residuals of about 3.6 ppm to about 5.0 ppm. Neither of these materials appears to be sufficiently effective at such low doses to be useful in large scale applications.

Polyaspartic acid has been blended with phosphonated anionic copolymers. This composition was limited to cooling tower waters and phosphate scales (U.S. Pat. No. 6,207,079 B1, U.S. Pat. No. 6,503,400 B2). These types of systems differ from the current application in that the level of salts present in the '079 and the '400 patents is considerably lower, the pH is higher, and improvement was only shown for phosphates.

Evaporative processes in regulated food and beverage market must contend with high conductivities ranging from about 10,000 micro Siemens per centimeter (μS/cm) to about 20,000 μS/cm. The pH can range from about 2.0 (lemon/lime, blueberry, wine, cranberry) to about 9.0 (milk, sugar) with high levels of solids (>10%). Cooling waters are typically well below 8,000 μS/cm and have a pH greater than 7.2. The plant matter can often bring high levels of phosphates and sulfates, as high as about 10,000-20,000 ppm with significant amounts of calcium, magnesium, and other metals not typically present in such high levels in other circulating water systems.

The use of the present “three-component” blend polymer treatment will have the benefit of minimizing the use of energy, increasing production, decreasing the time and chemicals used for cleaning, and thereby lessen the need for outages and downtime. By “three-component” blend we mean the combination of a) a polyamino acid, b) an anionic carboxylic polymer, and c) a polymaleic acid. An additional benefit of the present polymer treatment is the decreased maintenance of heat exchangers and evaporators.

The current “three-component” composition also shows enhanced performance at inhibiting or preventing other scales and deposits to form. Deposit formation is a complicated process that can often occur when one type of scale combines with another to form a larger deposit. By inhibiting the oxalate scale benefits would be expected in the reduction of organic deposits such as pitches and stickies as well as inorganic scales such as silicates.

The present composition of a polyamino acid/anionic carboxylic polymer/polymaleic acid, was found to exhibit corrosion inhibition properties in a wide range of applications. This additional benefit over the use of the individual components alone or in combination with one or the other, can further inhibit scaling and thus decrease the cost of maintenance and related down time.

### SUMMARY OF THE INVENTION

This invention pertains to an anti-scaling composition comprising a polyamino acid, such as, polyaspartic acid (PAA), an anionic carboxylic polymer, such as polyacrylic acid, and a polymaleic acid (PMA). The composition is able to effectively stabilize calcium, magnesium, oxalate, sulfate, and phosphate salts that lead to scale formation in evaporative systems. This composition shows high levels of efficacy in high conductivity waters found in many evaporative systems such as sugar; bio-refining and other regulated systems.

The present compositions provide stabilization of salts such as calcium, magnesium, oxalate, sulfate, and phosphate salts by reacting together to inhibit scale formation; prevent contaminant growth and acts as a dispersant. Specifically, the composition is able to stabilize calcium oxalate and prevent the formation of scale in the presence of high levels of sulfates, phosphates, magnesium, and other cations and anions commonly found during evaporative stages or other processes involved in the refining of sugar, bio-refining, liqueur and beer, fruit and vegetable juice, and dairy products such as milk. The current process is comprised of treating an aqueous system with a) a low molecular weight polyamino acid, b) an anionic carboxylic polymer, and c) a polymaleic acid in a ratio compliant with regulatory requirements.

The compositions of the present invention are considered to be synergistic because while none of the material is individually shown to be effective salt stabilizers at the approved regulatory levels, the blend of polyamines, anionic carboxylic polymer, and polymaleic acid gives a level of performance unexpected and superior to each of the polymers alone. These blends are able to stabilize calcium, oxalate and phosphate scales more than would be expected based on the individual performance of each material. The polyamino acid/anionic carboxylic polymer/polymaleic acid blend is further advantageous over many other existing blends as the polyamino acid is known to be biodegradable and is a known corrosion inhibitor. The term blend is interchangeably used with pre-mixed, and is used to mean the three components are mixed together prior to being added to the aqueous system. However, the polyamines, anionic carboxylic polymer and polymaleic acid can be added to the system simultaneously or sequentially at various addition points as long as the three components have residence time with one another.

One aspect of the current method and composition is that the components of the composition are recognized as safe by the Regulatory Commission such that it does not compromise the potential end use of the product. Regulated products may be consumed by humans or livestock and the presence of the chemical additive cannot interfere with the use or end use of the product or by-products such as dry distiller grains.

In other embodiments, the invention pertains to a method for removing, cleaning, preventing, and/or inhibiting the formation of scaling such as calcium, magnesium, oxalate, sulfate, and phosphate scale, comprising adding to an aqueous system a combination of a polyaspartic acid, a polyacrylic acid, and a polymaleic acid, wherein the polyaspartic acid, polyacrylic acid, and polymaleic acid can be added pre-blended, sequentially or simultaneously as long as there is residence time of the three components together.

Additional objects, advantages, and features of what is claimed will be set forth in the description that follows and in part will become apparent to those skilled in the art upon examination of the following or may be learned by the practice of the technology. The objects and advantages of the presently disclosed and claimed inventive concepts will be realized and attained by means of the compositions and methods particularly pointed out in the appended claims, including the functional equivalents thereof.

### DRAWINGS

FIG. 1, shows a general schematic of the main features of the procedure for determining Cycles of Concentration (COC).

### DETAILED DESCRIPTION OF THE INVENTION

The present invention relates to a composition and method to remove, clean, prevent, and/or inhibit the formation of calcium, magnesium, oxalate, sulfate, and phosphate scale and deposits in an aqueous system. Furthermore, it relates to a method for controlling the formation of scale in aqueous systems and inhibiting scale deposition on surfaces such as heat exchanger and evaporator equipment.

In one embodiment a composition comprising a polyamino acid, an anionic carboxylic polymer, and a polymaleic acid is added to an aqueous system for controlling scaling. The composition can be added to an aqueous system premixed, simultaneously or sequentially. For example, the chemicals can be blended together or pre-mixed prior to introduction into the aqueous system, or the polyamino acid, anionic carboxylic polymer and polymaleic acid can be added separately, simultaneously, or they can be added sequentially at various points in a system as long as the chemicals can come into contact with or have residence time with each other in the system. The chemicals can also be added in any order.

In another embodiment, component (a) of the scale inhibitor composition is a polyamino acid, such as polyaspartic acid. This includes polyaspartic salts and derivatives of polyaspartic acid such as the anhydrides used to form polyaspartic acid. The polyamino acid can also comprise a copolymer of aspartic and succinct monomer units. The polyamino acids can have molecular weights ranging from about 500 grams per mole (g/mol) to about 10,000 g/mol, can be from about 1,000 g/mol to about 5,000 g/mol, and may be from about 1,000 g/mol to about 4,000 g/mol. The polyamino acid can be used as a salt, such as sodium or potassium salt.

In another embodiment, component (b) is an anionic carboxylic polymer or salt thereof, such as polyacrylic acid. The anionic carboxylic polymer can be produced by the polymerization of one or more monomers and can include one or more homopolymers, copolymers, terpolymers or tetrapolymers, etc. In addition, the anionic carboxylic polymer typically has an average molecular weight of from about 500 g/mol to about 20,000 g/mol and can be from about 1,000 g/mol to about 50,000 g/mol. These polymers and their method of synthesis are well known in the art.

In another embodiment, monomers that can provide the source for the carboxylic functionality for the anionic carboxylic polymer include acrylic acid, methacrylic acid, carboxy-methyl inulin, crotonic acid, isocrotonic acid, fumaric acid, and itaconic acid. Numerous co-monomers can be polymerized with the monomer containing the carboxylic functionality. Examples such as vinyl, allyl, acrylamide, (meth) acrylate esters, and hydroxyl esters such as hydroxypropyl esters, vinyl pyrrolidone, vinyl acetate, acrylonitrile, vinyl methyl ether, 2-acrylamido-2-methyl-propane sulphonic acid, vinyl or allyl sulphonic acid, styrene sulphonic acid, and combinations thereof. The molar ratio of carboxylic acid functionalized to co-monomer can vary over a wide range, such as from about 99:1 to 1:99, and can be from about 95:5 to 25:75.

It is also possible to employ anionic carboxylic polymers that contain a phosphonate or other phosphorous containing functionality in the polymer chain, preferably phosphino polycarboxylic acids such as those disclosed in U.S. Pat. No. 4,692,317 and U.S. Pat. No. 2,957,931, incorporated herein by reference.

In another embodiment, component (c) is polymaleic acid (PMA) and is also known as hydrolyzed polymaleic anhydride (HPMA) and may be used interchangeably through the application. Polymaleic acid can have an average molecular weight of from about 200 g/mol to about 1,500 g/mol and can be from about 300 g/mol to about 1,000 g/mol.

Other optional components or additives include phosphonobutane tricarboxylic, polyphosphates, phosphates, hydroxyethylidene diphosphonic acid, amino tri(methylene phosphonic acid), citric acid, gluconic acid, and other small organic acids.

The three components, polyamino acid, anionic carboxylic polymer, and polymaleic acid, can be considered the active ingredients of the three component compositions of the current invention. The amounts of these three ingredients together are referred to as “active agents” or “actives”. Therefore, concentrations and amounts of the polymers used herein are based on “active solids”.

The effective ratio of polyamino acid to anionic carboxylic polymer to polymaleic acid is from 1:9:1 to 9:1:9, can be from 1:3:1 to 1:1:1 and may be 1.7:1:1.4. The compositions have an effective pH range of from about 1 to about 9, can be from about 1 to about 6, and may be from about 1 to about 5. The composition functions over a wide range of temperatures of from about 5° C. to about 175° C. The three-component composition can be added to the regulated evaporative system at a dosage of from about 0.1 ppm to about 500 ppm, can be from about 1.0 ppm to about 50 ppm, and may be from 0.1 ppm to about 15 ppm based on total active solids.

The following examples illustrate specific embodiments of the invention. It is likely that many similar and equivalent embodiments of the invention will also apply outside of those specifically disclosed. One skilled in the art will appreciate that although specific compounds and conditions are outlined in the following examples, these compounds and conditions are not a limitation on the present invention.

### EXAMPLES

The invention has been described with reference to a preferred embodiment, those skilled in the art will understand that changes can be made and equivalent substitutions made for certain components without departing from the scope of the invention. Additionally, modifications may be made to adapt to specific conditions or materials without departing from the scope thereof. Additionally, any future changes in the regulations pertaining to the restricted dosage limits fall within the scope of this invention. It is intended that the invention not be limited to a particular embodiment disclosed but that the invention will include all embodiments falling with the scope of the claims.

### Example 1

Calcium oxalate is one of the main scale forming compounds in the targeted applications. Example 1, describes the efficiency of the present invention against calcium oxalate compared with each individual polymer and a blend of polyaspartic acid and polyacrylic acid as described in patent application US 2015/0251939 (WO 2015/134048 A1). The dosages are given in ppm as active solids for each polymer product. The test method used in the current study is described as follows:

### Test Method

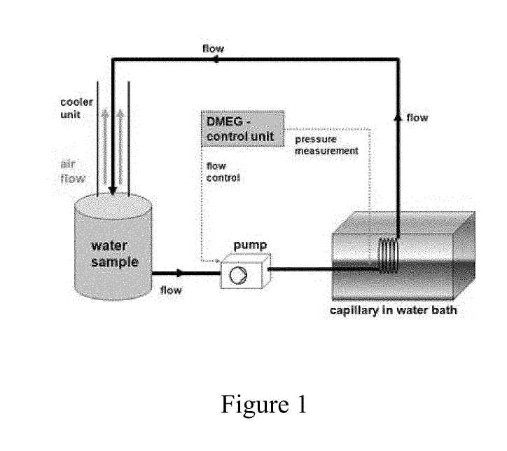

The test measurement was performed using a control unit to reproduce the recirculation process of a regulatory system. The control unit used in each of the following examples was a Druckmessgerat Haas V2.2 measurement and control unit (DMEG), manufactured by Franz-Josef Haas (see FIG. 1).

A constant volume flow of 2 [I/h] of a stoichiometric mixture prepared from a solution of calcium chloride di-hydrate and sodium oxalate in de-mineralized water was passed through a spiral metal capillary (length: 1 meter (m), inner diameter: 1.1 millimeter (mm) and placed in a heating bath at 40° C. The calculated calcium oxalate concentration was 110 milligram per liter (mg/L); calcium was added in a fivefold stoichiometrical ratio of oxalate. The pH of a calcium chloride di-hydrate solution was adjusted to 2.0 and the scale prevention polymers, i.e. PASP, PAA, PMA and combinations thereof, were added to the solution of calcium chloride di-hydrate followed by the sodium oxalate. However, the order is not of particular relevance and and the scale inhibition compositions could be added to the carbonate solutions or added to the solution of calcium chloride di-hydrate and sodium oxalate.

In this study, the individual polymers (PAA, PASP, and PMA), two-component blends of a) polyacrylic acid (PAA) with polymaleic acid (PMA); b) polyaspartic acid (PASP) with polymaleic acid (PMA); and c) polyacrylic acid (PAA) with polyaspartic acid (PASP), and three-component blend comprising PAA, PASP and PMA, were added to the solution of calcium chloride di-hydrate followed by sodium oxalate in de-mineralized water at 10 ppm total active solids. The dosages of the individual chemicals in the two-component and three-component blends can be found in Table 1, as ppm active solids.

TABLE 1
Dosages of Antiscaling Compositions

| | PAA | PASP | PMA | Total |
|---|---|---|---|---|
| PAA | 10 | | | 10 |
| PASP | | 10 | | 10 |
| PMA | | | 10 | 10 |
| PAA + PMA | 4.8 | | 5.2 | 10 |
| PMA + PASP | | 6.1 | 3.9 | 10 |
| PAA + PASP | 3.7 | 6.3 | | 10 |
| PAA + PASP + PMA | 2.6 | 4.5 | 2.9 | 10 |

A solution of calcium chloride di-hydrate, with and without anti-scaling polymers was mixed with sodium oxalate, magnesium chloride hexahydrate and di-sodium phosphate dodeca-hydrate in de-mineralized water and pumped in a circuit from a flask through a capillary in the water bath, through a cooler and back to the flask. In the water bath a heat exchange occurred and the temperature of the solution increased. The solution was then passed through a cooler unit where an adjusted air flow from below caused evaporation of the solution. During the study, samples of the solution of calcium chloride di-hydrate, with and without anti-scaling polymers, sodium oxalate, magnesium chloride hexahydrate and di-sodium phosphate dodeca-hydrate in de-mineralized water were taken and filtered through a 0.45 μm filter and concentration determinations of chloride and calcium, magnesium and phosphate were made.

Cycles of Concentration (COC) were calculated by dividing the analyzed concentration of a compound by the initial concentration. The chloride concentration describes the effective concentration of the system as the solubility of chloride is high. A loss of calcium by precipitation as calcium oxalate will result in a deviation of the COC for chloride and the COC for calcium. In this way, the maximum obtainable COC without scaling can be determined for each product at the equal dosage. The results can be seen in Table 2.

TABLE 2
Cycles of Concentration

| | Maximum Cycles of |
|---|---|
| | Concentration (COC) |
| Polyaspartic acid (PASP) | 1.5 |
| Polyacrylate (PAA) | 1.4 |
| Polymaleic acid (PMA) | 1.6 |
| Two-Component Blend (PAA + PMA) | 1.5 |
| Two-Component Blend (PMA + PASP) | 1.6 |
| Two-Component Blend (PASP/PAA) | 2.3 |
| Three Component Blend (PASP/PAA/PMA) | 2.7 |

As it can be seen the maximum COC reached with the “three-component” blend was significantly higher than with the individual polymers and the “two-component blends”. Although the same amount of anti-scaling composition was added to the system, the COC measured was higher than would have been expected from the results of the single polymer products and a synergistic anti-scaling effect is clearly seen with the “three-component” polymer blend.

### Example 2

This study evaluated the efficiency of a “three-component” anti-scaling composition comprising PASP, PAA and PMA, at inhibiting calcium carbonate deposition in comparison with each of the individual polymers (PASP, PAA and PMA), and two-component blends consisting of a) polyacrylic acid (PAA) with polymaleic acid (PMA); b) polyaspartic acid (PASP) with polymaleic acid (PMA); and c) polyacrylic acid (PAA) with polyaspartic acid (PASP) were included in this study. The dosages are given in ppm as total active solids for each product.

### Test Method

A solution of calcium chloride di-hydrate, sodium carbonate and sodium bicarbonate in de-mineralized water is stored in a heatable shaker bath. At increased temperature precipitations of calcium carbonate can form. After a defined period of time the solution is filtered, using a 0.45 μm—filter, and calcium concentration is determined in the filtrate. A stabilization value “S” can be calculated using the following equation, where the residual calcium concentration of the blank test, the residual concentration of the test with product and the initially prepared concentration is included. The higher the stabilization, the more calcium carbonate was kept from precipitating compared with the blank. The following procedure and parameters were applied. A 100 ml sample containing 500 ppm calcium as CaCO₃, 75 ppm CO₃²⁻ as CaCO₃ and 440 ppm HCO₃⁻ as CaCO₃ were stored for one hour at 80° C. in the shaker bath. The pH of the sample was 8.6. The scale inhibition compositions were added to the calcium chloride dehydrate followed by the sodium carbonate and sodium bicarbonate. However, the order of addition is not particularly relevant and the scale inhibition compositions could be added to the carbonate solutions or added to the solution of calcium chloride di-hydrate, sodium carbonate and sodium bicarbonate.

The anti-scaling compositions were used at 5 ppm and 10 ppm total active solids. The ratio of the “two-component” and “three-component” blends are found in Table 3, and indicates the dosage of the individual compounds as ppm active solids.

TABLE 3

| | Dosage 1 | | | | Dosage 2 | | | |
|---|---|---|---|---|---|---|---|---|
| | PAA | PASP | PMA | Total | PAA | PASP | PMA | Total |
| PAA | 5 | | | 5 | 10 | | | 10 |
| PASP | | 5 | | 5 | | 10 | | 10 |
| PMA | | | 5 | 5 | | | 10 | 10 |
| PAA + PMA | 2.4 | | 2.6 | 5 | 4.8 | | 5.2 | 10 |
| PMA + PASP | | 3 | 2 | 5 | | 6.1 | 3.9 | 10 |
| PAA + PASP | 1.85 | 3.15 | | 5 | 3.7 | 6.3 | | 10 |
| PAA + PASP + | 1.3 | 2.25 | 1.45 | 5 | 2.6 | 4.5 | 2.9 | 10 |
| PMA | | | | | | | | |

A stabilization value “S” was calculated using the following equation,

$$Stabilization S = \frac{( {[ {Ca}^{2 +} ]}_{with product} - {[ {Ca}^{2 +} ]}_{blank} )}{( {[ {Ca}^{2 +} ]}_{initial} - {[ {Ca}^{2 +} ]}_{blank} )} \cdot 100 \%$$

wherein [Ca²⁺]_{blank} is the residual calcium concentration of the solution of calcium chloride di-hydrate and sodium oxalate in de-mineralized water, [Ca²⁺]ᵢₙᵢₜᵢₐₗ is the residual concentration of the solution of calcium chloride di-hydrate and sodium oxalate in de-mineralized water with anti-scaling product, and [Ca²⁺]ᵢₙᵢₜᵢₐₗ is the initially prepared Ca²⁺ concentration of the solution of calcium chloride di-hydrate and sodium oxalate in de-mineralized water. The higher the stabilization, the more calcium carbonate was kept from precipitating out compared to the blank.

Table 4, indicates the stabilization value “S” when the system was dosed at 5 ppm and 10 ppm active solids with the anti-scaling compositions. Table 4, also includes a theoretical Stabilization “S” value in percent, considering the stabilization efficiency of the individual polymers and the respective composition of the “two-component” and “three-component” blends. For example, the theoretical Stabilization value of the two-component blend can be calculated as follows: (c1*S1+c2*S2)/(c1+c2)=(1.85*35 +3.15*16)/5=23; wherein c1 and c2 are the anti-scaling chemicals, and S1 and S2 is the stabilization value of the individual anti-scaling chemicals c1 and c2.

TABLE 4
Stabilization Values

| | Stabilization | | Theoretical Stabilization | |
|---|---|---|---|---|
| | “S” (%) | | “S” (%) | |
| | 5 parts-per- | 10 | 5 | 10 |
| | million (ppm) | ppm | ppm | ppm |
| PAA | 35 | 59 | | |
| PASP | 16 | 40 | | |
| PMA | 43 | 65 | | |
| PAA + PMA | 39 | 65 | 39 | 62 |
| PMA + PASP | 34 | 61 | 27 | 50 |
| PAA + PASP | 31 | 59 | 23 | 47 |
| PAA + PASP + PMA | 35 | 59 | 29 | 52 |

The calculated relative increase of the Stabilization value “S” given in % is shown in Table 5.

TABLE 5
Relative Increase of Stabilization “S”

Relative Increase of Stabilization “S”

| | 5 parts-per-million (ppm) | 10 ppm |
|---|---|---|
| PAA + PMA | 0 | 5 |
| PMA + PASP | 26 | 22 |
| PAA + PASP | 35 | 26 |
| PAA + PASP + PMA | 21 | 13 |

For the “two-component” blend of polyacrylic acid with polymaleic acid the Stabilization value “S” measured corresponds with the theoretical value calculated from the results of the individual compounds. The other compositions show a synergistic stabilization effect and the Stabilization value is clearly higher than the values expected based on the results when the individual compounds were used separately.

### Example 3

In many regulatory systems scale in the form of calcium oxalate and magnesium phosphate is generated. Example 3, compares the efficiency at inhibiting scaling of the present “three-component” blend with each of the individual polymers found in the blend and also with “two-component” blends of polyacrylic acid with polymaleic acid, polyaspartic acid with polymaleic acid, and polyacrylic acid with polyaspartic acid. The dosages are given in ppm as active solids for each product in Table 6.

### Test Method

A constant volume flow of 2 [I/h] of a mixture prepared from a solution of calcium chloride di-hydrate, sodium oxalate, magnesium chloride hexahydrate and di-sodium phosphate dodeca-hydrate in de-mineralized water was passed through a spiral metal capillary (length: 1 (m), inner diameter: 1.1 (mm)) placed in a heating bath at 90° C. The initial concentrations of calcium, oxalate, magnesium and phosphate used in this study were as follows: 5 mg/l calcium, 10 ppm oxalate, 230 ppm magnesium, 800 ppm phosphate. The pH was adjusted to 6.0. The scale inhibition compositions were added to the solution of calcium chloride di-hydrate followed by sodium oxalate, magnesium chloride hexahydrate and di-sodium phosphate dodeca-hydrate in de-mineralized water.

The scale inhibition compositions were added to the solution of calcium chloride di-hydrate followed by sodium oxalate, magnesium chloride hexahydrate and di-sodium phosphate dodeca-hydrate in de-mineralized water at 40 ppm total active solids. The ratio of the “two-component” and “three-component” blends were set to regulatory limits. Table 6 indicates the dosage of the anti-scaling compositions as parts-per-million (ppm) active solids.

TABLE 6
Anti-Scaling Dosages

| | PAA | PASP | PMA | Total |
|---|---|---|---|---|
| PAA | 40 | | | 40 |
| PASP | | 40 | | 40 |
| PMA | | | 40 | 40 |
| PAA + PMA | 19 | | 21 | 40 |
| PMA + PASP | 14.8 | 24.3 | 15.7 | 40 |
| PAA + PASP | 10.4 | 25.2 | | 40 |
| PAA + PASP + PMA | 10.4 | 18 | 11.6 | 40 |

A solution of calcium chloride di-hydrate, with and without anti-scaling polymers was mixed with sodium oxalate, magnesium chloride hexahydrate and di-sodium phosphate dodeca-hydrate in de-mineralized water and pumped in a circuit from a flask through a capillary in the water bath, through a cooler and back to the flask. In the water bath a heat exchange occurred and the temperature of the solution increased. The solution was then passed through a cooler unit where an adjusted air flow from below caused evaporation of the solution. During the study, samples of the solution of calcium chloride di-hydrate, with and without anti-scaling polymers, sodium oxalate, magnesium chloride hexahydrate and di-sodium phosphate dodeca-hydrate in de-mineralized water were taken and filtered through a 0.45 p.m filter and concentration determinations of chloride, calcium, magnesium and phosphate were made.

The Cycles of Concentration (COC) were calculated as described in Example 1. Results are indicated in Table 7.

TABLE 7
Maximum Cycles of Concentration

| | Maximum Cycles of |
|---|---|
| | Concentration |
| PAA | 3.0 |
| PASP | 1.9 |
| PMA | 2.0 |
| PAA + PMA | 2.1 |
| PMA + PASP | 2.0 |
| PAA + PASP | 2.0 |
| PAA + PASP + PMA | 3.0 |

The results indicated that a significantly higher COC can be reached by adding a third component to the two-component blend, while keeping the same dosage. The “three-component” blend surprisingly reaches the performance of the best polymer PAA although a high ratio of the lower performing PMA and PASP is part of the blend.

1. A method for controlling, preventing and/or inhibiting the formation of calcium, magnesium, oxalate, sulfate, and phosphate scaling and/or deposits in a regulated evaporative system comprising;
adding to the regulated evaporative system a mixture comprising a) a polyamino acid; b) an anionic carboxylic polymer; c) and a polymaleic acid; wherein the polyamino acid, anionic carboxylic polymer, and polymaleic acid has residence time together and is added to the regulated evaporative system premixed, simultaneously or sequentially and in any order.

2. The method according to claim 1, wherein the polyamino acid, anionic carboxylic polymer and polymaleic acid are premixed prior to being added to the regulated evaporative system.

3. The method of claim 3, wherein the calcium and/or magnesium scale is from oxalates and phosphates.

4. The method of any one of claims 1-4, wherein the composition comprises a polyamino acid in an amount of from about 2 ppm to about 100 ppm by weight regulated evaporative system, can be from about 3 ppm to about 50 ppm by weight regulated evaporative system, and may be from about 5 ppm to about 10 ppm by weight regulated evaporative system.

5. The method of any one of claims 1-5, wherein the polyamino acid has an average molecular weight ranging from about 500 g/mol to about 10,000 g/mol, can be from about 1,000 to about 5,000 g/mol, and may be from about 1,000 g/mol to about 4,000 g/mol.

6. The method of any one of claims 1-6, wherein the polyamino acid is a sodium or potassium salt.

7. The method of claim 6 or 7, wherein the polyamino acid is polyaspartate.

8. The method of any one of claims 1-8, wherein the anionic carboxylic polymer has an average molecular weight ranging from about 500 g/mol to about 20,000 g/mol and can be from about 1,000 g/mol to about 50,000 g/mol.

9. The method of any one of claims 1-9, wherein the composition comprises an anionic carboxylic polymer in an amount of from about 2 ppm to about 100 ppm by weight regulated evaporative system, can be from about 3 ppm to about 50 ppm by weight regulated evaporative system, and may be from about 5 ppm to about 10 ppm by weight regulated evaporative system.

10. The method of any one of claims 1-10, wherein the anionic carboxylic polymer is selected from at least one of homopolymers, copolymers, terpolymers and tetrapolymers

11. The method of any one of claims 1-11, wherein the anionic carboxylic polymer is selected from the group consisting of acrylic/sulfonic polymers, acrylic/maleic copolymers, phosphinocarboxylic, acryl/maleic/sulfonated styrene, acrylic/ethoxylate/acrylamide, maleic/ethylacrylate/vinyl acetate and mixtures thereof.

12. The method of any one of claims 1-12, wherein the polymaleic acid has an average molecular weight of from about 200 g/mol to about 1,500 g/mol and can be from about 300 g/mol to about 1,000 g/mol.

13. The method of any one of claims 1-13, wherein the composition comprises polymaleic acid in an amount of from about 2 ppm to about 100 ppm by weight regulated evaporative system, can be from about 3 ppm to about 50 ppm by weight regulated evaporative system, and may be from about 5 ppm to about 10 ppm by weight regulated evaporative system.

14. The method of any one of claims 1-14, wherein the total concentration of the composition added to the regulated evaporative system is from about 0.1 ppm to about 500 ppm based on active solids and may be from about 1.0 ppm to about 50.0 ppm based on active solids.

15. The method of any one of claims 1-13, wherein the composition optionally contains citric acid, sodium phosphate, tartaric acid, gluconic acid, and/or small organic acids.

16. The method of any one of claims 1-14, wherein the pH of the regulated evaporative system is from about 1.0 to about 9.0; can be from about 2.5 to about 7; and may be from about 3.0 to about 5.0.

17. The method of claim 15, wherein the pH of the regulated evaporative system is from about 3.0 to about 5.0.

18. The method of any one of claims 1-16, wherein the temperature of the regulated evaporative system is from about 5° C. to about 175° C.; and can be from about 40° C. to about 80° C.

19. The method of any one of claims 1-17, wherein the regulated evaporative system comprises heat exchangers and/or evaporating equipment.

20. The method of any one of claims 1-18, wherein the regulated evaporative system is selected from the group consisting of regulated food process for direct or indirect food consumption; bio-refinery and fuel ethanol processes; sugar processing; fruit and vegetable juice concentrating processes; and food, alcohol and fermentation processes.

21. The method of claim 19, wherein the alcohol or fermentation process comprises beer, wine and concentrate liquors.

22. The method of claim 19, wherein the regulated food processes comprise milk and dairy processes.

23. A composition for controlling, preventing and/or inhibiting the formation of scale and/or deposits in an regulated evaporative system comprising;
a) a polyaspartic acid in an amount of from about 2 ppm to about 100 ppm by weight regulated evaporative system; b) an anionic carboxylic polymer in an amount of from about 2 ppm to about 100 ppm by weight regulated evaporative system; and c) a polymaleic acid in an amount of from about 2 ppm to about 100 ppm by weight regulated evaporative system.
